(19) United States
(12) Patent Application Publication
(10) Pub. No.: US 2010/0272410 A1
(43) Pub. Date: Oct. 28, 2010

(54) RADIUS LIMITER CABLE RETENTION BRACKET, CLAMP AND PANEL

(76) Inventors: DENNIS KRAMPOTICH, SHAKOPEE, MN (US); RYAN KOSTECKA, BURNSVILLE, MN (US)

Correspondence Address: MERCHANT & GOULD PC, P.O. BOX 2903, MINNEAPOLIS, MN, 55402-0903, US

(21) Appl. No.: 12/764,258

(22) Filed: Apr. 21, 2010

Related U.S. Application Data
(60) Provisional application No. 61/172,582, filed on Apr. 24, 2009.

(51) Int. Cl. G02B 6/00

(52) U.S. Cl. 385/136; 385/135

(57) ABSTRACT

The present disclosure relates to a cable retention bracket including four sides defining an interior for containing fiber optic cables. One of the sides defines a pivoting closure member that defines a hinge axis generally transverse to the direction of cables passing through the cable retention bracket. At least one of the sides includes a curved surface defining a cable radius limiter surface for providing bend radius protection for the cables. The various sides are made from a sheet metal construction. The cable retention bracket is usable in a variety of panels, trays, and drawers for managing telecommunications cables. A cable clamp includes two threaded sockets, a pad member and an elongated cover positioned over the pad member, with first and second threaded fasteners mounting the cover over the pad member.

### CROSS REFERENCE TO RELATED APPLICATION

This application claims the benefit of provisional application Ser. No. 61/172,582, filed Apr. 24, 2009, which is incorporated herein by reference in its entirety.

### TECHNICAL FIELD

This disclosure concerns management of optical fiber cables.

### BACKGROUND

Cable management arrangements for cable termination, splice, and storage come in many forms. One cable management arrangement used in the telecommunications industry today includes sliding trays or drawers installed on telecommunication equipment racks. The trays and drawers provide organized, high density, cable termination, splice, and storage in telecommunication infrastructures that often have limited space.

Because telecommunication infrastructures are massive in scale, the original installation and subsequent adaptation of the infrastructures can be difficult to manage. Accordingly, the ability to adapt cable management arrangements and schemes is important. There is a continued need in the art for better cable management devices and arrangements.

### SUMMARY

The present disclosure relates to a cable retention bracket including four sides defining an interior for containing fiber optic cables. One of the sides defines a pivoting closure member that defines a hinge axis generally transverse to the direction of cables passing through the cable retention bracket. In one embodiment, at least one of the sides includes a curved surface defining a cable radius limiter surface for providing bend radius protection for the cables. In one embodiment, the various sides are made from a sheet metal construction. The cable retention bracket is usable in a variety of panels, trays, and drawers for managing telecommunications cables.

The present disclosure also relates to a cable clamp including first and second threaded sockets positioned on a fixture. A pad member is positioned on the fixture between the first and second sockets. An elongated cover is positioned over the pad member. A first threaded fastener mounts the first end of the cover to the first threaded socket. A second threaded fastener mounts the second end of the cover to the second threaded socket. A cable path is defined between a top surface of the pad and a bottom surface of the cover. The cover pivots about a hinge axis defined by one of the threaded fasteners generally transverse to the direction of cables in the cable path. The cable clamp is useable in a variety of panels, trays, and drawers for managing telecommunications cables.

### BRIEF DESCRIPTION OF THE DRAWINGS

FIG. 1 is a front perspective view of a portion of one embodiment of a cable management panel according to the principles of the present disclosure, with portions removed for clarity;

FIG. 2 is a front perspective view of the panel of FIG. 1, without cables, connectors, and adapters, with portions removed for clarity;

FIG. 3 is a side view of the cable management panel of FIG. 2, with portions removed for clarity;

FIG. 4 is a top view of the cable management panel of FIG. 2;

FIG. 5 is a front perspective view of an opposite side of the cable management panel of FIG. 1, with the cable management bracket shown in an open position;

FIG. 6 is a top view of cable management panel of FIG. 5;

FIG. 7 is a perspective view of the closure member of the cable retention bracket;

FIG. 8 is an exploded perspective view of the cable retention bracket;

FIG. 9 is a front perspective view of a portion of another embodiment of a cable management panel according to the principles of the present disclosure;

FIG. 10 is a rear perspective view of the cable management panel of FIG. 9;

FIG. 11 is a perspective view showing details of the cable clamp; and

FIG. 12 is an exploded view of the cable clamp of FIG. 11.

### DETAILED DESCRIPTION

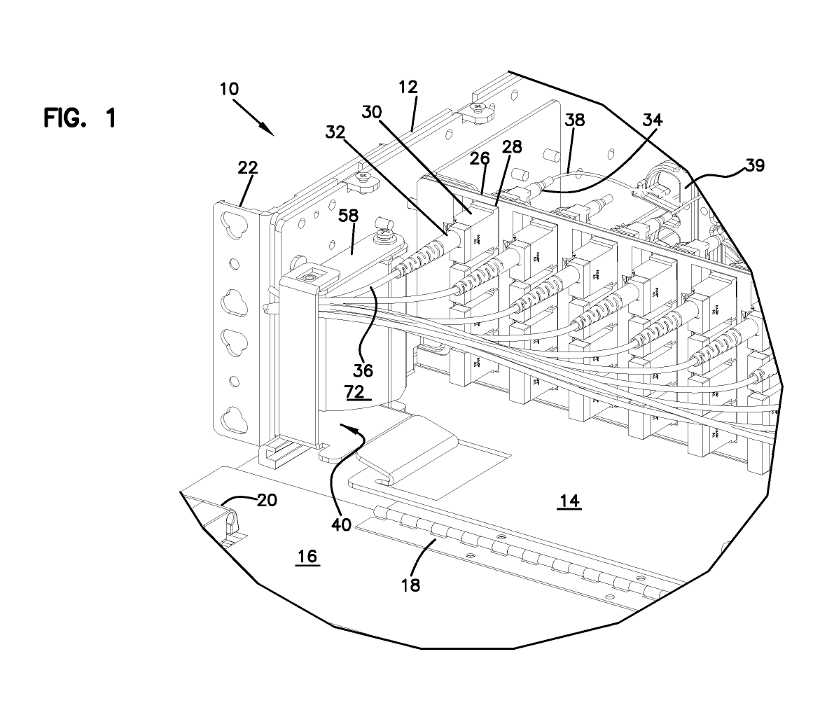

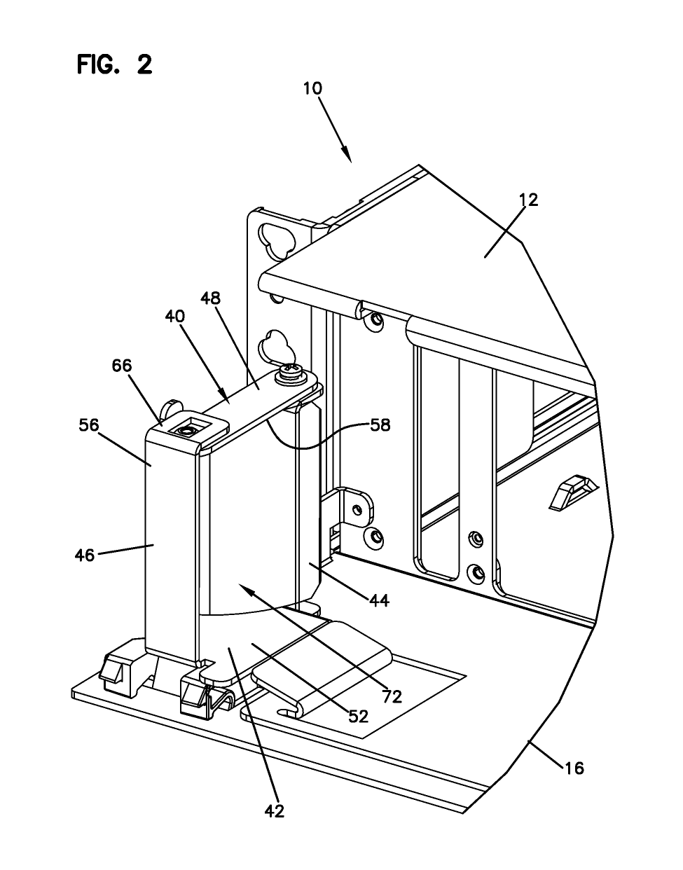

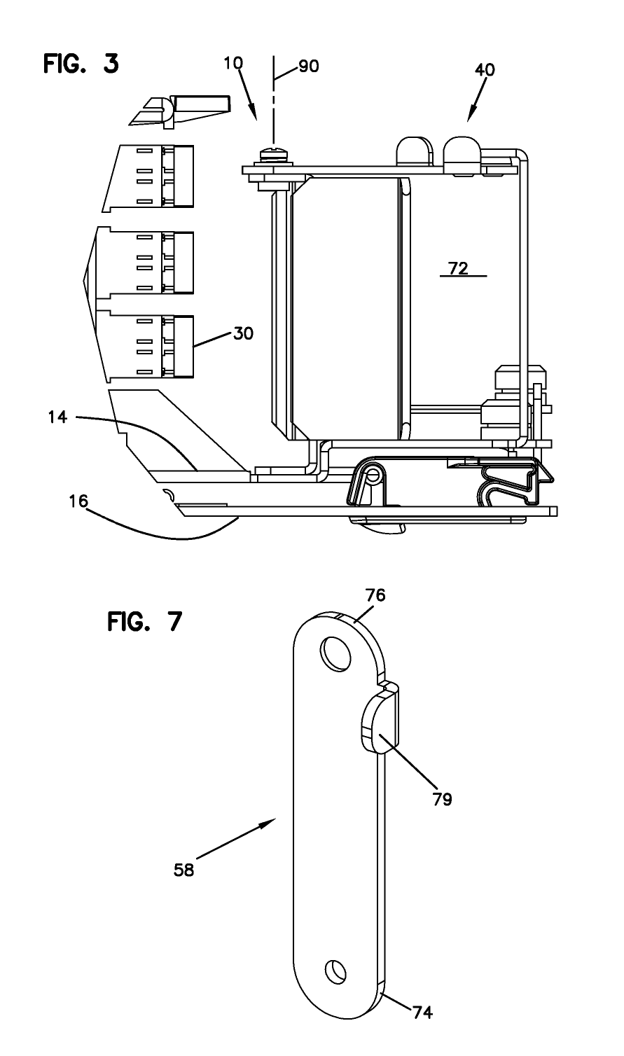

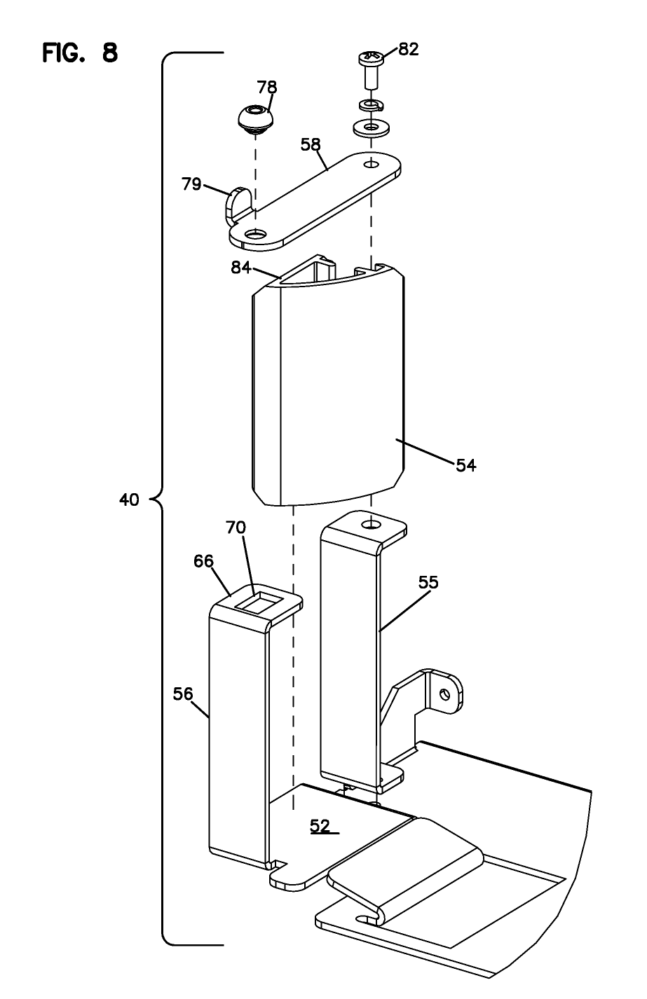

Referring now to FIGS. 1-8, a cable management panel 10 is shown. Panel 10 includes a chassis 12, and a tray 14. In the illustrated embodiment, tray 14 is movable from an interior position in chassis 12 to an extended position relative to chassis 12. A door 16 closes a front of chassis 12. A hinge 18 joins door 16 to chassis 12. A latch 20 holds door 16 in a closed position relative to chassis 12. Panel 12 mounts with flanges 22 to a telecommunications rack.

Panel 10 includes a bulkhead 26 mounted on tray 14 in the illustrated embodiment. Bulkhead 26 defines a plurality of fiber termination locations 28. Fiber termination locations 28 include fiber optic adapters 30 which allow for signal transmission between two connectors 32, 34 located on opposite sides of bulkhead 26. Connectors 32, 34 terminate fiber optic cables 36, 38.

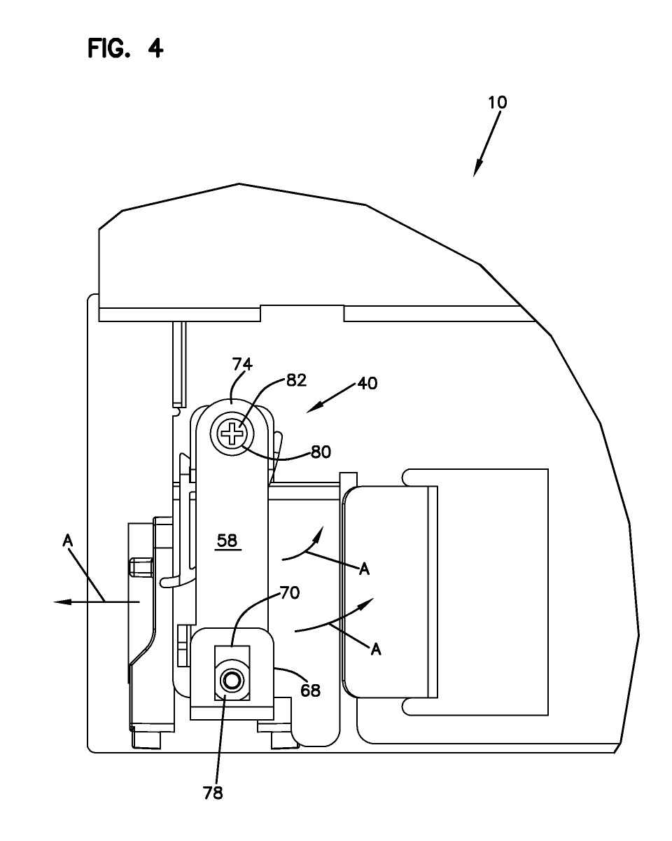

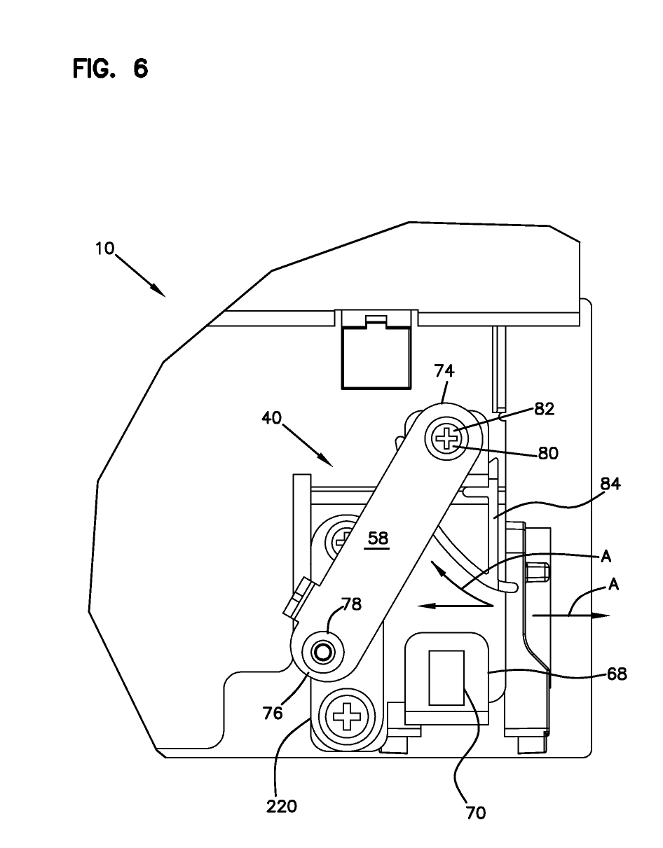

Panel 10 includes various structure for managing cables 36, 38. Fanning guide 39 manages rear cables 38. One structure for managing front cables 36 is cable retention bracket 40. In the illustrated embodiment, two cable retention brackets 40 are provided, one on each opposite side of tray 14. Cable retention bracket 40 includes four sides 42, 44, 46, 48. In the embodiment in FIGS. 1-7, side 42 defines a base 52. Side 44 defines a radius limiter 54 for providing cable bend radius protection. Radius limiter 54 mounts to arm 55. Side 46 defines an arm 56 opposite radius limiter 54. Arm 56 includes a tab 66 and an opening 70. Side 48 defines a closure member 58 movable between positions to access an interior 72 of cable retention bracket 40. Interior 72 receives cables during use to manage the cables. Arrows A in FIGS. 4 and 6 show the cable paths.

Closure member 58 of cable retention bracket 40 includes a pivot end 74 and an opposite distal end 76. Distal end 76 includes a protrusion 78 which retains closure member 58 in the closed position as shown in FIGS. 1-4. Protrusion 78 is received in opening 70 of tab 68.

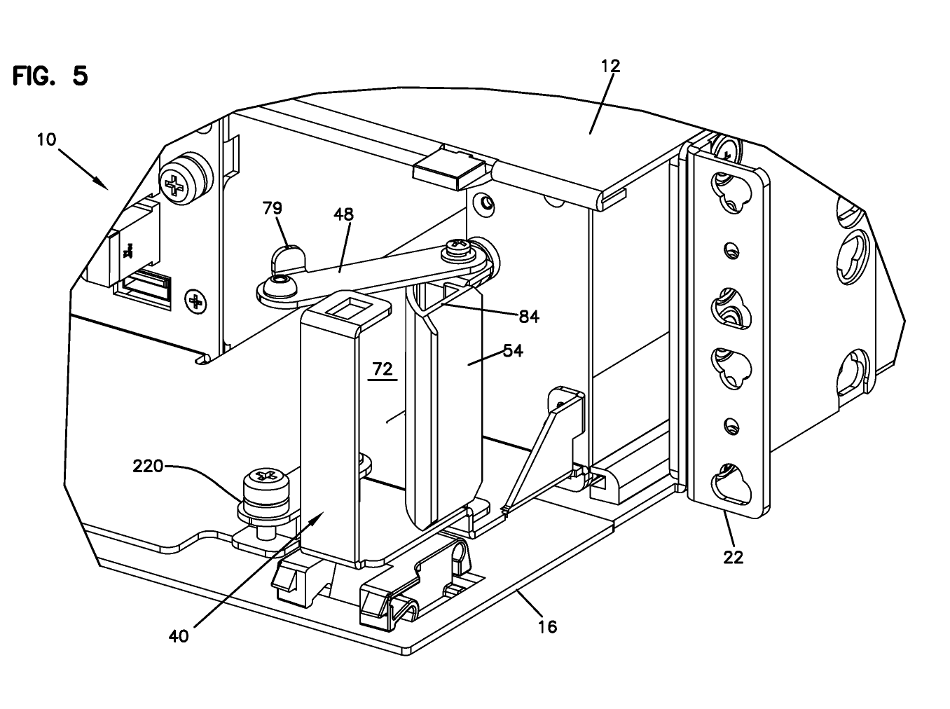

A hinge 80 allows closure member 58 to pivot to an open position as shown in FIGS. 5 and 6 from the closed position of FIGS. 1-4. Hinge 80 includes a fastener 82, which connects pivot end 74 of closure member 58 to side 44. Radius limiter 54 further defines a support surface 84 for supporting closure member 58 during operation. As shown, support surface 84 supports closure member 58 in the closed position of FIGS. 1-4, and in the open position of FIGS. 5 and 6, and in positions in between. Closure member 58 includes a tab 79 which can be accessed by a user to move closure member 58 between positions. Tab 79 also acts as a stop to prevent closure member 58 from pivoting too far past the closed position during closing.

In the illustrated embodiment, the closure member 58 pivots about a hinge axis 90 which is generally transverse to the direction of the cable pathway through interior 72 of cable retention bracket 40. It is to be noted that axis 90 can pass through passage 72, or be adjacent to as in the embodiment of FIGS. 1-7.

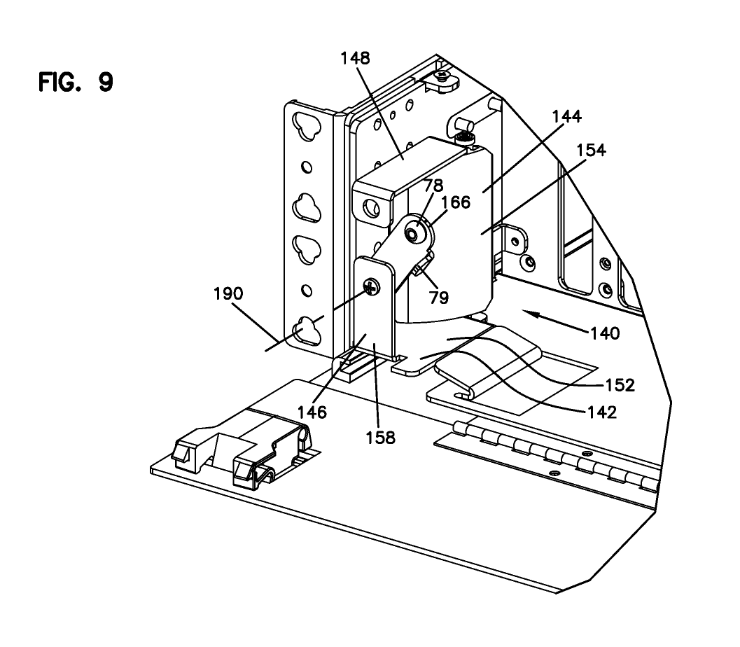

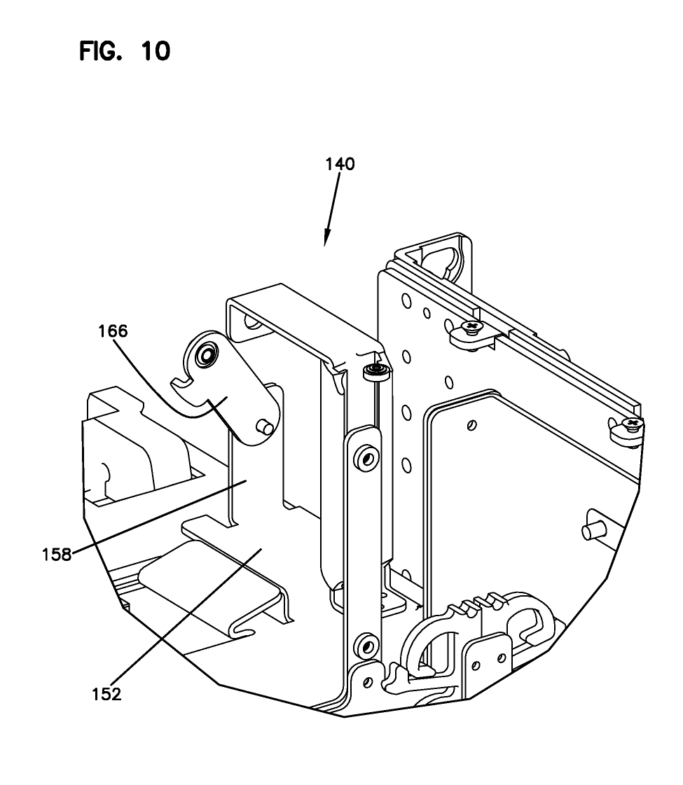

Referring now to FIGS. 9 and 10, an alternative cable retention bracket 140 is shown. Bracket 140 includes four sides 142, 144, 146 and 148. Side 142 defines a base 152. Side 144 defines a radius limiter 154. Side 146 includes a stationary arm 156 and a pivoting closure member 166. Pivoting closure member 166 includes a protrusion 178 which is received in opening 170 of arm 156. As with cable retention bracket 40, cable retention bracket 140 has closure member 166 having a hinge axis 190 transverse to the fiber path through cable retention bracket 140.

Cable retention brackets 40, 140 can be made from a variety of materials. Radius limiters 54, 154 can be snap on plastic parts, and the rest of brackets 40, 140 can be made from sheet metal. Cable reduction brackets 40, 140 can be used in a variety of panels and other equipment to manage cables. Brackets 40, 140 can be used in other orientations, too.

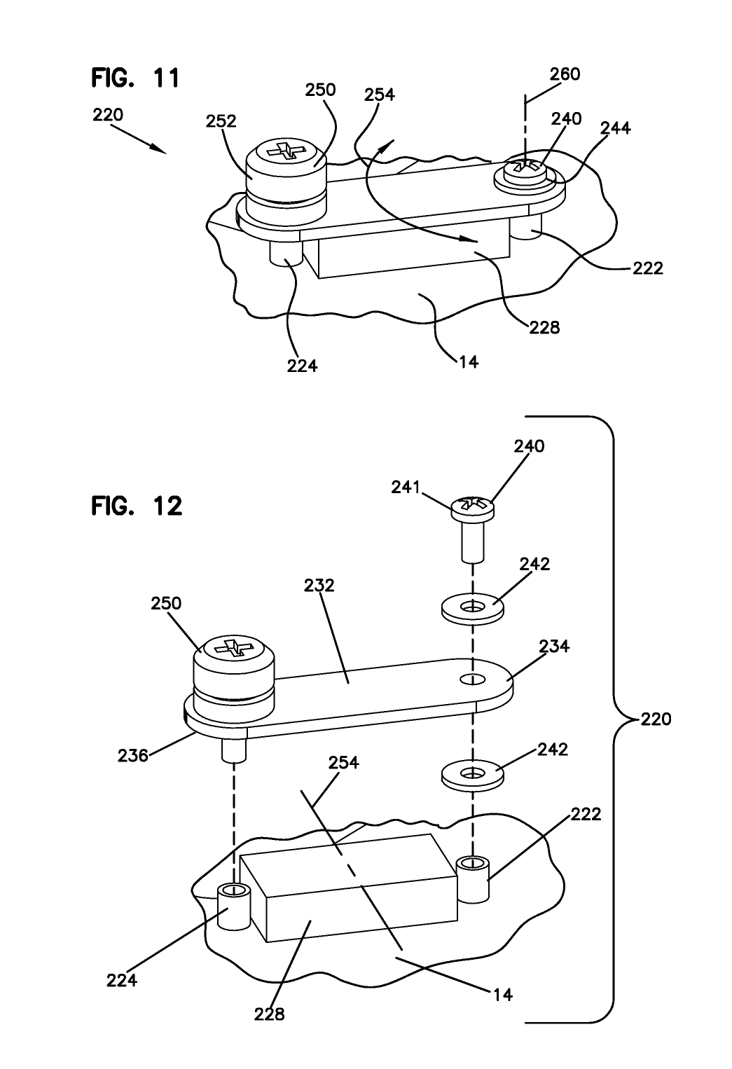

Referring now to FIGS. 11 and 12, a cable clamp 220 of cable management panel 10 is shown. Cable clamp 220 is also visible in FIGS. 5 and 6, adjacent to the right cable retention bracket 40. Cable clamp 220 includes a first threaded socket 222, and a second threaded socket 224 spaced from the first threaded socket 222. A pad member is positioned on tray 14 between the first and second threaded sockets 222, 224. The pad member is made from a compressible and resilient material, such as foam.

An elongated cover 232 includes first and second ends 234, 236. Cover 232 is positioned over pad member 228. A first threaded fastener 240 mounts first end 234 of cover 232 to first threaded socket 222. First and second washers 242 are positioned above and below cover 232. Together these elements form a hinge axis 260 for cover 232 to pivot to allow cable access below the cover. A second threaded fastener 250 mounts second end 236 of cover 232 to second threaded socket 224. Head 252 of fastener 250 includes a griping surface (e.g., knurled) for griping by a user's fingers to tighten and untighten second fastener 250 with second threaded socket 224. Head 252 is longer than head 241 of first threaded fastener 240. This helps identify second fastener 250 for access by the user to open and close the clamp.

By selectively disconnecting second fastener 250 from second threaded socket 224, cover 232 can be pivoted toward and away from pad 228 about axis 260. A cable pathway 254 is defined across a top of pad 228. When cover 232 is positioned over pad 228, cables are retained in an organized manner in cable pathway 254. By applying slight pressure on the cables in cable pathway 254 from cover 232 and/or pad member 228, the cables resist being pulled or sliding relative to cable clamp 220.

Cable clamp 220 can be used in combination with cable retention bracket 40, or alone.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A cable retention device comprising:
a body having first, second, third, and fourth sides, wherein one of the sides defines a pivoting closure member, wherein the first, second, third, and fourth sides surround an interior of the body, wherein a cable pathway is defined through the body in a longitudinal direction, wherein a hinge axis of the closure member is positioned in a transverse direction to the cable pathway.

2. The cable retention device of claim 1, wherein at least one of the first, second, third, and fourth sides defines a curved radius limiter surface.

3. The cable retention device of claim 1, wherein the pivoting closure member includes a first interlock element which interlocks with a reciprocally shaped second interlock element on another of the first, second, third, and fourth sides to retain the closure member in a closed position.

4. The cable retention device of claim 1, wherein the pivoting closure member is positioned opposite to a radius limiter surface defined by one of the first, second, third, and fourth sides.

5. The cable retention device of claim 1, wherein the pivoting closure member is positioned adjacent to a radius limiter surface defined by one of the first, second, third, and fourth sides.

6. The cable retention device of claim 1, wherein the pivoting closure member is positioned opposite to a pad member, and two of the first, second, third and fourth sides are defined by threaded fasteners and mating threaded sockets.

7. A cable retention bracket comprising:
a body having first, second, third, and fourth sides, wherein one of the sides defines a pivoting closure member, wherein the first, second, third, and fourth sides surround an interior of the body, wherein a cable pathway is defined through the body in a longitudinal direction, wherein a hinge axis of the closure member is positioned in a transverse direction to the cable pathway, wherein at least one of the first, second, third, and fourth sides defines a curved radius limiter surface, wherein the pivoting closure member includes a first interlock element which interlocks with a reciprocally shaped second interlock element on another of the first, second, third, and fourth sides to retain the closure member in a closed position, wherein the first, second, third, and fourth sides include a sheet metal construction.

8. The cable retention bracket of claim 7, wherein the pivoting closure member is positioned opposite to a radius limiter surface defined by one of the first, second, third, and fourth sides.

9. The cable retention bracket of claim 7, wherein the pivoting closure member is positioned adjacent to a radius limiter surface defined by one of the first, second, third, and fourth sides.

10. A cable clamp comprising:
a fixture;
a first threaded socket on the fixture;
a second threaded socket on the fixture spaced from the first threaded socket;
a pad member on the fixture positioned between the first and second threaded sockets;
an elongated cover with first and second ends positioned over the pad member;
a first threaded fastener mounting the first end of the cover to the first threaded socket;
a second threaded fastener mounting the second end of the cover to the second threaded socket, wherein a cable path is defined between a top surface of the pad member and a bottom surface of the cover.

11. The cable clamp of claim 10, wherein the pad member includes a compressible and resilient material.

12. The cable clamp of claim 10, wherein a head of the second fastener is longer along a longitudinal axis of the second fastener than a head of the first fastener.
